(19) United States
(12) Patent Application Publication
(10) Pub. No.: US 2021/0320312 A1
(43) Pub. Date: Oct. 14, 2021

(54) METHOD AND DEVICE FOR PREDICTING SERVICE LIFE AND REMAINING LIFE OF FUEL CELL

(71) Applicant: Tsinghua University, Beijing (CN)

(72) Inventors: Pucheng PEI, Beijing (CN); Bozheng WANG, Beijing (CN); Dongfang CHEN, Beijing (CN); Shangwei HUANG, Beijing (CN); Peng REN, Beijing (CN)

(21) Appl. No.: 17/224,705

(22) Filed: Apr. 7, 2021

(30) Foreign Application Priority Data
Apr. 13, 2020 (CN) 202010285041.5
Apr. 13, 2020 (CN) 202010285680.1
Apr. 17, 2020 (CN) 202010303823.7

(51) Int. Cl. H01M 8/04992; H01M 8/04858

(52) U.S. Cl. CPC H01M 8/04992; H01M 8/04902; H01M 8/04873

(57) ABSTRACT

Provided are method and device for predicting service life and remaining life of a fuel cell. The method includes: activating the fuel cell, obtaining an initial polarization curve of the fuel cell, and selecting a first point having a first current in the initial polarization curve; determining a life end point of the fuel cell according to the initial polarization curve and a decay ratio; obtaining a current polarization curve, and determining a second point having a second current and a same voltage as the first point in the current polarization curve; and determining the service life of the fuel cell according to the first current, the second current, a current relationship between two polarization curves and a service life algorithm of the fuel cell, and obtaining the remaining life of the fuel cell according to the service life and a time of the current polarization curve.

### CROSS REFERENCE TO RELATED APPLICATION

This application claims priority to and benefits of Chinese Patent Application Serial Nos. 202010285041.5 and 202010285680.1, filed with the National Intellectual Property Administration of P. R. China on Apr. 13, 2020, and Chinese Patent Application Serial No. 202010303823.7, filed with the National Intellectual Property Administration of P. R. China on Apr. 17, 2020. The entire contents of the aforementioned application are incorporated by reference herein.

### FIELD

The present disclosure relates to a field of fuel cell technology, and more particularly to a method and a device for predicting a service life and a remaining life of a fuel cell.

### BACKGROUND

Fuel cell is used as a new type of energy source and has advantages in energy conservation and emission reduction. In the study and development of the fuel cell, service life and remaining life of the fuel cell are usually considered as parameters for evaluating the performance of the fuel cell. Therefore, there is a need for predicting the service life of the fuel cell. However, existing methods for predicting the service life and the remaining life are complex, need a long time and have a narrow scope of application.

### SUMMARY

Embodiments of the present disclosure seek to solve at least one of the problems existing in the related art to at least some extent.

In embodiments of a first aspect of the present disclosure, a method for predicting service life and remaining life of a fuel cell is provided. The method includes:

activating the fuel cell, obtaining an initial polarization curve of the fuel cell, and selecting a first point having a first current in the initial polarization curve;

determining a life end point of the fuel cell according to the initial polarization curve and a decay ratio;

obtaining a current polarization curve of the fuel cell, and determining a second point having a second current in the current polarization curve, wherein the second point has the same voltage as the first point; and

determining the service life of the fuel cell according to the first current, the second current, a relationship between two polarization curves in current, and a service life algorithm of the fuel cell, and obtaining the remaining life of the fuel cell according to the service life and a time of the current polarization curve.

In an embodiment of the present disclosure, the fuel cell includes a proton exchange membrane fuel cell, a direct methanol fuel cell, and a solid oxide fuel cell.

In an embodiment of the present disclosure, the currents of the initial and current polarization curves meet a formula (1):

$$\frac{I}{{I}_{0}} = exp ( - \frac{t - {t}_{0}}{B} ) \qquad ( 1 )$$

where I₀ represents the first current corresponding to a set voltage Vₛ of the initial polarization curve, I represents the second current corresponding to the set voltage Vₛ of the current polarization curve, B represents a logarithmic decay constant, t₀ represents a time of the initial polarization curve, that is a period from a time when activation of the fuel cell is complete to a time when the initial polarization curve is obtained, and t represents the time of the current polarization curve, that is a period from the time when the activation of the fuel cell is complete to a time when the current polarization curve is obtained.

In an embodiment of the present disclosure, the logarithmic decay constant B is obtained by:

obtaining a third polarization curve and a fourth polarization curve of the fuel cell at two different times;

obtaining a third point of the third polarization curve according to the set voltage Vₛ, wherein the third point has a third current Iₘ;

obtaining a fourth point of the fourth polarization curve according to the set voltage Vₛ, wherein the fourth point has a fourth current Iₙ; and

determining the logarithmic decay coefficient B of the fuel cell according to the third current Iₘ and the fourth current Iₙ with a formula (2):

$$B = \frac{{t}_{n} - {t}_{m}}{ln {I}_{m} - ln {I}_{n}} \qquad ( 2 )$$

where tₘ represents a period from the time when the activation of the fuel cell is complete to a time when the third polarization curve is obtained, and tₙ represents a period from the time when the activation of the fuel cell is complete to a time when the fourth polarization curve is obtained.

In an embodiment of the present disclosure, the service life algorithm of the fuel cell comprises a formula (3):

$${t}_{fc} = - B \cdot ln ( \frac{{I}_{b}}{{I}_{0}} ) + {t}_{0} \qquad ( 3 )$$

where t_{fc} represents the service life of the fuel cell, and I_{b} represents a current at the life end point of the fuel cell.

In an embodiment of the present disclosure, the decay ratio is a current ratio of a current difference between the first current and the current I_{b} at the life end point to the first current.

In an embodiment of the present disclosure, the decay ratio is in a range of 5% to 70%.

In an embodiment of the present disclosure, the service life algorithm of the fuel cell comprises a formula (4):

$$\begin{matrix}{V}_{t} = {V}_{0} + {rI}_{b} ( 1 - exp ( \frac{t - {t}_{0}}{B} ) ) + \frac{R T}{2 F} ln ( \frac{{i}_{L} \cdot exp ( ( {t}_{0} - t ) / B ) - {I}_{b}}{{i}_{L} - {I}_{b}} ) \\ {t}_{f c} = t {\vert}_{{V}_{t} - {V}_{e}}\end{matrix} \} \qquad ( 4 )$$

where V₀ represents an ideal electromotive force of the initial polarization curve of the fuel cell, I_{b} represents a current corresponding to a voltage Vₛ after the fuel cell is running for a time t, r represents an internal resistance of the fuel cell, R represents the gas constant, 8.31444 J/(K·mol), T represents a temperature, F represents the Faraday constant, 96485 C/mol, i_{L} represents a limiting current of the initial polarization curve, Vₜ represents a voltage of the fuel cell, Vₑ represents a voltage at the life end point of the fuel cell, and t_{fc} represents the service life of the fuel cell.

In an embodiment of the present disclosure, the decay ratio is a voltage ratio of a voltage difference between the ideal electromotive force and the voltage at the life end point to the ideal electromotive force.

In an embodiment of the present disclosure, the decay ratio is in a range of 5% to 70%.

In an embodiment of the present disclosure, the currents of the initial and current polarization curves meet a formula (5):

$$\frac{I}{{I}_{0}} = \frac{1}{1 + k ( t - {t}_{0} )} \qquad ( 5 )$$

where I₀ represents the first current corresponding to a set voltage Vₛ of the initial polarization curve, I represents the second current corresponding to the set voltage Vₛ of the current polarization curve, k represents a reciprocal decay constant, t₀ represents a time of the initial polarization curve, that is a period from a time when activation of the fuel cell is complete to a time when the initial polarization curve is obtained, and t represents the time of the current polarization curve, that is a period from the time when the activation of the fuel cell is complete to a time when the current polarization curve is obtained.

In an embodiment of the present disclosure, the reciprocal decay constant k is obtained by:

obtaining a third polarization curve and a fourth polarization curve of the fuel cell at two different times;

obtaining a third point of the third polarization curve according to the set voltage Vₛ, wherein the third point has a third current Iₘ;

obtaining a fourth point of the fourth polarization curve according to the set voltage Vₛ, wherein the fourth point has a fourth current Iₙ; and

determining the reciprocal decay coefficient k of the fuel cell according to the first current I₀, the third current Iₘ and the fourth current Iₙ with a formula (6):

$$k = \frac{{I}_{0}}{{t}_{m} - {t}_{n}} \cdot ( \frac{1}{{I}_{m}} - \frac{1}{{I}_{n}} ) \qquad ( 6 )$$

where tₘ represents a period from the time when the activation of the fuel cell is complete to a time when the third polarization curve is obtained, and to represents a period from the time when the activation of the fuel cell is complete to a time when the fourth polarization curve is obtained.

In an embodiment of the present disclosure, the service life algorithm of the fuel cell comprises a formula (7):

$${t}_{f c} = \frac{{I}_{0}}{k} ( \frac{1}{{I}_{b}} - \frac{1}{{I}_{0}} ) + {t}_{0} \qquad ( 7 )$$

where t_{fc} represents the service life of the fuel cell, and I_{b} represents a current at the life end point of the fuel cell.

In an embodiment of the present disclosure, the remaining life of the fuel cell is obtained by subtracting the time of the current polarization curve from the service life.

In embodiments of a second aspect of the present disclosure, a device for predicting service life and remaining life of a fuel cell is provided. The device includes: an electronic load, configured to connect to the fuel cell; a measuring assembly, configured to obtain current and voltage information of the fuel cell and record time; a processor; a memory having stored therein a computer program that, when executed by the processor, causes the processor to perform the method for predicting service life and remaining life of the fuel cell as described above.

In embodiments of a second aspect of the present disclosure, provided is a computer-readable storage medium having stored therein instructions that, when executed by a processor, are configured to perform the method for predicting service life and remaining life of the fuel cell as described above.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a method for predicting service life and remaining life of a fuel cell according to an embodiment of the present disclosure;

FIG. 2 is a schematic diagram showing two polarization curves of a fuel cell according to an embodiment of the present disclosure;

FIG. 3 is a schematic diagram showing two polarization curves of a fuel cell according to another embodiment of the present disclosure;

FIG. 4 is a block diagram of a device for predicting service life and remaining life of a fuel cell according to an embodiment of the present disclosure; and

FIG. 5 is a block diagram of an apparatus for predicting service life and remaining life of a fuel cell according to an embodiment of the present disclosure.

### DETAILED DESCRIPTION

Embodiments of the present disclosure will be described in details in the following descriptions, and it will be apparent that the described embodiments are only part of the embodiments of the present disclosure. All other embodiments which can be obtained by those skilled in the art without making any inventive work based on embodiments described in the present disclosure are within the scope of the present disclosure.

In the following, method, device and apparatus for predicting service life and remaining life of a fuel cell are provided, which are capable of simplifying prediction process and shortening the time used for the prediction.

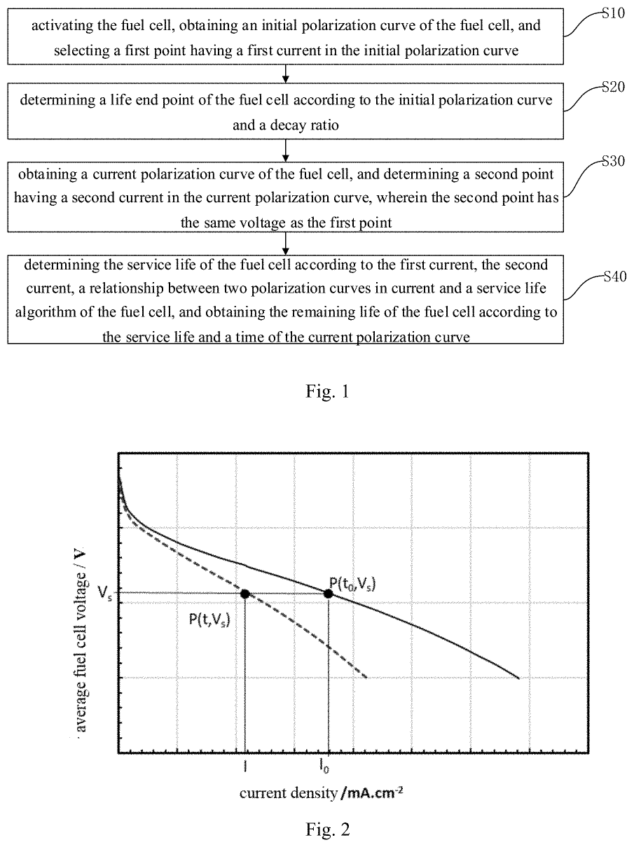

FIG. 1 is a flow chart of a method for predicting service life and remaining life of a fuel cell according to an embodiment of the present disclosure. The fuel cell may be a proton exchange membrane fuel cell, a direct methanol fuel cell or a solid oxide fuel cell. As shown in FIG. 1, the method may include following steps.

In S10, the fuel cell is activated, an initial polarization curve of the fuel cell is obtained, and a first point having a first current in the initial polarization curve is selected.

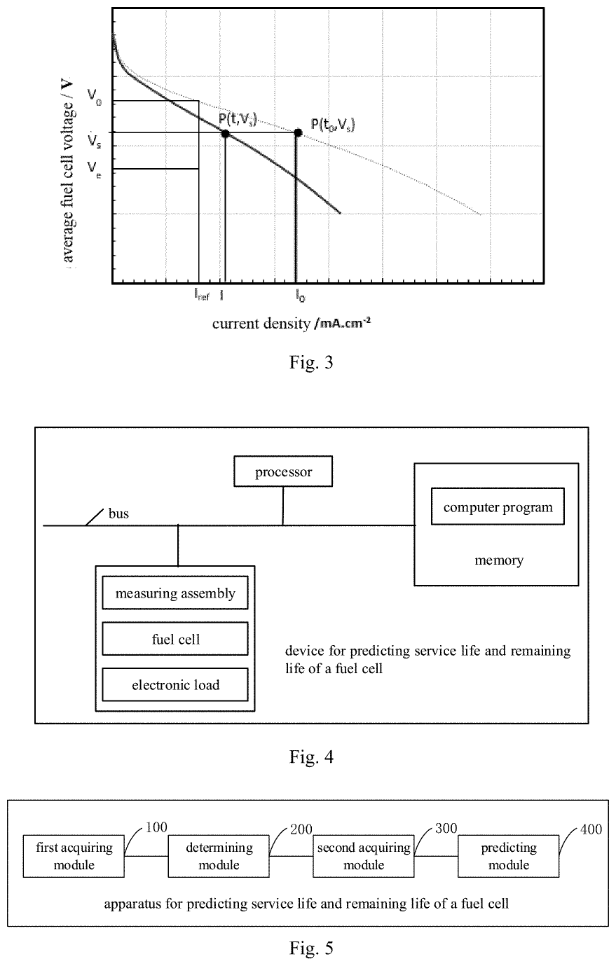

Before the fuel cell works, the fuel cell is activated, for example in common manner/device known in the art. After the activation of the fuel cell is completed, the fuel cell starts working. The initial polarization curve of the fuel cell is obtained during working. As shown in FIG. 2, a solid line represents the initial polarization curve which is obtained at time t₀, or as shown in FIG. 3, a dotted line represents the initial polarization curve which is obtained at time t₀. In other words, t₀ represents the time of the initial polarization that is a period from a time when the activation of the fuel cell is complete to a time when the initial polarization curve is obtained. The first point P with a voltage Vₛ is selected. The voltage Vₛ may be any suitable value, for example, 0.6-0.7 V. Corresponding to the voltage Vₛ, the first current I₀ is obtained.

It should be noted that during the activation of the fuel cell to be tested is activated, if abnormal phenomena such as performance degradation occur, the fuel cell should be replaced with a new fuel cell in the same type and this new fuel cell is subjected to the activation.

In S20, a life end point of the fuel cell is determined according to the initial polarization curve and a decay ratio.

After obtaining the polarization curve of the fuel cell in its initial state, the life end point is determined by the decay ratio in current or in voltage. For example, the decay ratio may be a current ratio of a current difference between the first current and a current at a life end point to the first current in the initial polarization curve. In this case, the ratio may be determined according to practice, such as in a range of 5% to 70%, for example 10%. That is, after the first current is obtained, and the decay ratio is for example determined to be 10%, a current difference between the first current and a current at the same voltage is 10% of the first current, this current at the same voltage is determined as the current at the life end point and thus the life end point is determined. For another example, the decay ratio may be a voltage ratio of a voltage difference between the ideal electromotive force and a voltage at a life end point to the ideal electromotive force. As shown in FIG. 3, a dotted line represents the initial polarization curve which is obtained at time t₀. A current I_{ref} is selected according to practice, for example in a range of 500 to 1500 mA/cm². A voltage V₀ corresponding to the current I_{ref} represents an ideal electromotive force of the initial polarization curve of the fuel cell. The ratio may be determined according to practice, such as in a range of 5% to 70%. On this basis, when the decay ratio is determined as 10%, a voltage Vₑ at the life end point meets a formula: (V₀−Vₑ)/V₀=10%.

In S30, a current polarization curve of the fuel cell is obtained, a second point having a second current in the current polarization curve is determined, and the second point has the same voltage as the first point.

After the fuel cell is operated for a period of time, and the polarization curve of the fuel cell in the current state is obtained. As shown in FIG. 2, a dotted line represents the current polarization curve which is obtained at time t, or as shown in FIG. 3, a solid line represents the current polarization curve which is obtained at time t. In other words, t represents the time of the current polarization, that is, a period from a time when the activation of the fuel cell is complete to a time when the current polarization curve is obtained. At the same set voltage Vₛ as the initial polarization curve, the second point of the current polarization curve is obtained, and a current at the second point is the second current I.

In S40, the service life of the fuel cell is determined according to the first current, the second current, a relationship between two polarization curves in current, and a service life algorithm of the fuel cell, and the remaining life of the fuel cell is obtained according to the service life and a time of the current polarization curve.

In an embodiment, the fuel cell is aged as the fuel cell works, and at a set constant voltage, current and time of the fuel cell may be related to each other and constitute an exponential function. For example, based on the first point of the initial polarization curve and the second point of the current polarization curve as described above, the currents of the initial and current polarization curves meet a formula (1):

$$\frac{I}{{I}_{0}} = exp ( - \frac{t - {t}_{0}}{B} ) \qquad ( 1 )$$

where I₀ represents the first current corresponding to a set voltage Vₛ of the initial polarization curve, I represents the second current corresponding to the set voltage Vₛ of the current polarization curve, B represents a logarithmic decay constant, t₀ represents a time of the initial polarization curve, that is a period from a time when activation of the fuel cell is complete to a time when the initial polarization curve is obtained, and t represents the time of the current polarization curve, that is a period from the time when the activation of the fuel cell is complete to a time when the current polarization curve is obtained.

The logarithmic decay constant B may be obtained from currents and times of any two polarization curves obtained during the operation of the fuel cell. In an embodiment, the logarithmic decay constant B is obtained by obtaining a third polarization curve and a fourth polarization curve of the fuel cell at two different times; obtaining a third point of the third polarization curve according to the set voltage Vₛ, the third point having a third current Iₘ; obtaining a fourth point of the fourth polarization curve according to the set voltage Vₛ, the fourth point having a fourth current Iₙ; and determining the logarithmic decay coefficient B of the fuel cell according to the third current Iₘ and the fourth current Iₙ with a formula (2):

$$B = \frac{{t}_{n} - {t}_{m}}{ln {I}_{m} - ln {I}_{n}} \qquad ( 2 )$$

where tₘ represents a time of the third polarization curve that is a period from the time when the activation of the fuel cell is complete to a time when the third polarization curve is obtained, and tₙ represents a time of the fourth polarization curve that is a period from the time when the activation of the fuel cell is complete to a time when the fourth polarization curve is obtained.

It should be understood that after the two polarization curves at different times during the operation of the fuel cell are obtained, and currents corresponding to a constant voltage may be obtained from the two polarization curves as the third current and the fourth current. The constant voltage here may be any suitable voltage, for example, equal to the voltage Vₛ selected for the initial polarization curve and the current polarization curve.

On the basis of the logarithmic decay coefficient B obtained, the service life of the fuel cell can be calculated by a service life algorithm. For example, in a case where the fuel cell is considered to be unusable when its current reaches the current I_{b} at the life end point, the service life t_{fc} of the fuel cell may be obtained by the service life algorithm with a formula (3):

$${t}_{fc} = - B \cdot ln ( \frac{{I}_{b}}{{I}_{0}} ) + {t}_{0} \qquad ( 3 )$$

where t_{fc} represents the service life of the fuel cell, that is a period from the time when the activation of the fuel cell is complete to a time when a final polarization curve is obtained. In such a curve, a current at the voltage Vₛ is I_{b}.

The method for predicting the service life and the remaining life of the fuel cell of the present disclosure may be based on logarithmic characteristic of the fuel cell. In the embodiments, the logarithmic relationship is formed between current and running time of the fuel cell. After the activation of the fuel cell, two polarization curve of the fuel cell are obtained at different times. The service life and the remaining life can be obtained according to the two curves, the logarithmic relationship and the service life algorithm. In this way, the method is less complex and is easy to operate, thus reducing cost and time for predicting the service life of the fuel cell, and improving the accuracy of the prediction. Therefore, the present method may be widely applied to various types of fuel cells.

In another embodiment, the life end point of the fuel cell may be determined on the basis of the voltage. As described above, a voltage Vₑ at the life end point is obtained from the ideal electromotive force V₀ and the decay ratio. In this case the service life t_{fc} of the fuel cell may be obtained by the service life algorithm with a formula (4):

$$\begin{matrix}{V}_{t} = {V}_{0} + {rI}_{b} ( 1 - exp ( \frac{t - {t}_{0}}{B} ) ) + \frac{R T}{2 F} ln ( \frac{{i}_{L} \cdot exp ( ( {t}_{0} - t ) / B ) - {I}_{b}}{{i}_{L} - {I}_{b}} ) \\ {t}_{f c} = t {\vert}_{{V}_{t} - {V}_{e}}\end{matrix} \} \qquad ( 4 )$$

where V₀ represents the ideal electromotive force of the initial polarization curve of the fuel cell, I_{b} represents a current corresponding to a voltage Vₛ after the fuel cell is running for a time t, r represents an internal resistance of the fuel cell, R represents the gas constant, 8.31444 J/(K·mol), T represents a temperature, F represents the Faraday constant, 96485 C/mol, i_{L} represents a limiting current of the initial polarization curve, Vₜ represents a voltage of the fuel cell, Vₑ represents a voltage at the life end point of the fuel cell, and t_{fc} represents the service life of the fuel cell.

The method for predicting the service life and the remaining life of the fuel cell of the present disclosure may be based on polarization-like characteristic of the fuel cell. In the embodiments, the logarithmic relationship is formed between current and running time of the fuel cell. After the activation of the fuel cell, two polarization curve of the fuel cell are obtained at different times. The service life and the remaining life can be obtained according to the two curves, the logarithmic relationship and the service life algorithm. In this way, the method is less complex and is easy to operate, thus reducing cost and time for predicting the service life of the fuel cell, and improving the accuracy of the prediction. Therefore, the present method may be widely applied to various types of fuel cells.

In a further embodiment, based on the first point of the initial polarization curve and the second point of the current polarization curve as described above, the currents of the initial and current polarization curves meet a formula (5):

$$\frac{I}{{I}_{0}} = \frac{1}{1 + k ( t - {t}_{0} )} \qquad ( 5 )$$

where I₀ represents the first current corresponding to a set voltage Vₛ of the initial polarization curve, I represents the second current corresponding to the set voltage Vₛ of the current polarization curve, k represents a reciprocal decay constant, t₀ represents a time of the initial polarization curve, that is a period from a time when activation of the fuel cell is complete to a time when the initial polarization curve is obtained, and t represents the time of the current polarization curve, that is a period from the time when the activation of the fuel cell is complete to a time when the current polarization curve is obtained.

The reciprocal decay constant k may be obtained from currents and times of any two polarization curves obtained during the operation of the fuel cell. In an embodiment, the reciprocal decay constant k is obtained by obtaining a third polarization curve and a fourth polarization curve of the fuel cell at two different times; obtaining a third point of the third polarization curve according to the set voltage Vₛ, the third point having a third current Iₘ; obtaining a fourth point of the fourth polarization curve according to the set voltage Vₛ, the fourth point having a fourth current Iₙ; and determining the reciprocal decay coefficient k of the fuel cell according to the first current I₀, the third current Iₘ and the fourth current Iₙ with a formula (6):

$$k = \frac{{I}_{0}}{{t}_{m} - {t}_{n}} \cdot ( \frac{1}{{I}_{m}} - \frac{1}{{I}_{n}} ) \qquad ( 6 )$$

where tₘ represents a period from the time when the activation of the fuel cell is complete to a time when the third polarization curve is obtained, and to represents a period from the time when the activation of the fuel cell is complete to a time when the fourth polarization curve is obtained.

On the basis of the reciprocal decay constant k, the service life of the fuel cell can be calculated by a service life algorithm. As described above, the fuel cell is considered to be unusable when its current reaches the current I_{b} at the life end point, the service life t_{fc} of the fuel cell may be obtained by the service life algorithm with a formula (7):

$${t}_{f c} = \frac{{I}_{0}}{k} ( \frac{1}{{I}_{b}} - \frac{1}{{I}_{0}} ) + {t}_{0} \qquad ( 7 )$$

where t_{fc} represents the service life of the fuel cell, that is a period from the time when the activation of the fuel cell is complete to a time when a final polarization curve is obtained. In such a curve, a current at the voltage Vₛ is I_{b}.

The method for predicting the service life and the remaining life of the fuel cell of the present disclosure may be based on reciprocal characteristic of the fuel cell. In the embodiments, the reciprocal relationship is formed between current and running time of the fuel cell. After the activation of the fuel cell, two polarization curve of the fuel cell are obtained at different times. The service life and the remaining life can be obtained according to the two curves, the reciprocal relationship and the service life algorithm. In this way, the method is less complex and is easy to operate, thus reducing cost and time for predicting the service life of the fuel cell, and improving the accuracy of the prediction. Therefore, the present method may be widely applied to various types of fuel cells.

After the service life of the fuel cell is obtained, the remaining life of the fuel cell may be obtained by subtracting the time of the current polarization curve from the service life.

In another aspect of the present disclosure, a device for predicting service life and remaining life of a fuel cell is provided in embodiments.

FIG. 4 is a block diagram of a device for predicting service life and remaining life of a fuel cell according to an embodiment of the present disclosure. As shown in FIG. 4, the device for predicting service life and remaining life of a fuel cell includes an electronic load, a measuring assembly, a processor and a memory having stored therein a computer program. Specifically, a communication bus may be provided to realise communications among the components. The electronic load is configured to connect to the fuel cell. When the load is connected to the fuel cell, a circuit is formed and the fuel cell provides powder to the load. The measuring assembly is configured to obtain current and voltage information of the fuel cell and record time. Information and data recorded are provided to the processor for further process. The processor may be used to control the circuit and the measuring assembly. The memory stores therein a computer program that, when executed by the processor, causes the processor to perform the steps of the method for predicting service life and remaining life of the fuel cell as follows:

activating the fuel cell, obtaining an initial polarization curve of the fuel cell, and selecting a first point having a first current in the initial polarization curve;

determining a life end point of the fuel cell according to the initial polarization curve and a decay ratio;

obtaining a current polarization curve of the fuel cell, and determining a second point having a second current in the current polarization curve, wherein the second point has the same voltage as the first point; and

determining the service life of the fuel cell according to the first current, the second current, a relationship between two polarization curves in current, and a service life algorithm of the fuel cell, and obtaining the remaining life of the fuel cell according to the service life and a time of the current polarization curve.

Specifically, the processor may refer to the apparatuses shown in FIG. 5, which will be described as follows.

In still another aspect of the present disclosure, an apparatus for predicting service life and remaining life of a fuel cell is provided in embodiments.

FIG. 5 is a block diagram of an apparatus for predicting service life and remaining life of a fuel cell according to an embodiment of the present disclosure. As shown in FIG. 5, the apparatus includes a first acquiring module 100, a determining module 200, a second acquiring module 300 and a predicting module 400. The first acquiring module 100 is configured to obtain an initial polarization curve of the fuel cell, and select a first point having a first current in the initial polarization curve. The determining module 200 is configured to determine a life end point of the fuel cell according to the initial polarization curve and a decay ratio. The second acquiring module 300 is configured to obtain a current polarization curve of the fuel cell, and determine a second point having a second current in the current polarization curve, wherein the second point has the same voltage as the first point. The predicting module 400 is configured to determine the service life of the fuel cell according to the first current, the second current, a relationship between two polarization curves in current, and a service life algorithm of the fuel cell, and obtain the remaining life of the fuel cell according to the service life and a time of the current polarization curve.

The present disclosure provides a computer-readable storage medium having stored therein instructions that, when executed by a processor, are configured to perform the steps of the method for predicting service life and remaining life of the fuel cell as follows:

activating the fuel cell, obtaining an initial polarization curve of the fuel cell, and selecting a first point having a first current in the initial polarization curve;

determining a life end point of the fuel cell according to the initial polarization curve and a decay ratio;

obtaining a current polarization curve of the fuel cell, and determining a second point having a second current in the current polarization curve, wherein the second point has the same voltage as the first point; and

determining the service life of the fuel cell according to the first current, the second current, a relationship between two polarization curves in current, and a service life algorithm of the fuel cell, and obtaining the remaining life of the fuel cell according to the service life and a time of the current polarization curve.

It should be noted that all of the above described features and advantages for the method for predicting service life and remaining life of a fuel cell as described above are also applicable to the device and apparatus for predicting service life and remaining life of a fuel cell, which will not be elaborated in detail herein.

### Example 1

A fuel cell to be tested is connected to an electronic load. After activation, an initial polarization curve of the fuel cell is obtained, and a first point having a first current in the initial polarization curve is selected. A life end point of the fuel cell is determined according to the initial polarization curve and a decay ratio. A current polarization curve of the fuel cell is obtained, a second point having a second current in the current polarization curve is determined, and the second point has the same voltage as the first point. The service life of the fuel cell is determined according to the first current, the second current, a relationship between two polarization curves in current, and a service life algorithm of the fuel cell with the following formulas:

$$\begin{matrix}\frac{I}{{I}_{0}} = exp ( - \frac{t - {t}_{0}}{B} ) & ( 1 ) \\ {t}_{fc} = - B \cdot ln ( \frac{{I}_{b}}{{I}_{0}} ) + {t}_{0} & ( 3 )\end{matrix}$$

where t_{fc} represents the service life of the fuel cell, I₀ represents the first current corresponding to a set voltage Vₛ of the initial polarization curve, I represents the second current corresponding to the set voltage Vₛ of the current polarization curve, B represents a logarithmic decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, and I_{b} represents a current at the life end point of the fuel cell.

After the service life of the fuel cell is obtained, the remaining life of the fuel cell is obtained by subtracting the time t of the current polarization curve from the service life t_{fc}.

### Example 2

A fuel cell to be tested is connected to an electronic load. After activation, an initial polarization curve of the fuel cell is obtained, and a first point having a first current in the initial polarization curve is selected. A life end point of the fuel cell is determined according to the initial polarization curve and a decay ratio. A current polarization curve of the fuel cell is obtained, a second point having a second current in the current polarization curve is determined, and the second point has the same voltage as the first point. The service life of the fuel cell is determined according to the first current, the second current, a relationship between two polarization curves in current, and a service life algorithm of the fuel cell with the following formulas:

$$\begin{matrix}\frac{I}{{I}_{0}} = exp ( - \frac{t - {t}_{0}}{B} ) & ( 1 ) \\ \begin{matrix}{V}_{t} = {V}_{0} + {rI}_{b} ( 1 - exp ( \frac{t - {t}_{0}}{B} ) ) + \frac{R T}{2 F} ln ( \frac{{i}_{L} \cdot exp ( ( {t}_{0} - t ) / B ) - {I}_{b}}{{i}_{L} - {l}_{b}} ) \\ {t}_{f c} = t {\vert}_{{V}_{t} = {V}_{e}}\end{matrix} \} & ( 4 )\end{matrix}$$

where I₀ represents the first current corresponding to a set voltage Vₛ of the initial polarization curve, I represents the second current corresponding to the set voltage Vₛ of the current polarization curve, B represents a logarithmic decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, V₀ represents the ideal electromotive force of the initial polarization curve of the fuel cell, I_{b} represents a current corresponding to a voltage Vₛ after the fuel cell is running for a time t, r represents an internal resistance of the fuel cell, R represents the gas constant, 8.31444 J/(K·mol), T represents a temperature, F represents the Faraday constant, 96485 C/mol, i_{L} represents a limiting current of the initial polarization curve, Vₜ represents a voltage of the fuel cell, Vₑ represents a voltage at the life end point of the fuel cell, and t_{fc} represents the service life of the fuel cell.

After the service life of the fuel cell is obtained, the remaining life of the fuel cell is obtained by subtracting the time t of the current polarization curve from the service life t_{fc}.

### Example 3

A fuel cell to be tested is connected to an electronic load. After activation, an initial polarization curve of the fuel cell is obtained, and a first point having a first current in the initial polarization curve is selected. A life end point of the fuel cell is determined according to the initial polarization curve and a decay ratio. A current polarization curve of the fuel cell is obtained, a second point having a second current in the current polarization curve is determined, and the second point has the same voltage as the first point. The service life of the fuel cell is determined according to the first current, the second current, a relationship between two polarization curves in current, and a service life algorithm of the fuel cell with the following formulas:

$$\begin{matrix}\frac{I}{{l}_{0}} = \frac{1}{1 + k ( t - {t}_{0} )} & ( 5 ) \\ {t}_{f c} = \frac{{I}_{0}}{k} ( \frac{1}{{I}_{b}} - \frac{1}{{I}_{0}} ) + {t}_{0} & ( 7 )\end{matrix}$$

where t_{fc} represents the service life of the fuel cell, I₀ represents the first current corresponding to a set voltage Vₛ of the initial polarization curve, I represents the second current corresponding to the set voltage Vₛ of the current polarization curve, k represents a reciprocal decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, and I_{b} represents a current at the life end point of the fuel cell.

After the service life of the fuel cell is obtained, the remaining life of the fuel cell is obtained by subtracting the time t of the current polarization curve from the service life t_{fc}.

### Example 4

Processes of activating a fuel cell, obtaining initial polarization curve and current polarization curve of the fuel cell and determining service life and remaining life in this example are the same as Example 2, expect for that the logarithmic decay constant B is obtained from a third point of a third polarization curve and a fourth point of a fourth polarization curve of the fuel cell at two different times. In this case, the service life of the fuel cell is determined according to the first current, the second current, a relationship between two polarization curves in current, and a service life algorithm of the fuel cell with the following formulas:

$$\begin{matrix}\frac{I}{{I}_{0}} = exp ( - \frac{t - {t}_{0}}{B} ) & ( 1 ) \\ B = \frac{{t}_{n} - {t}_{m}}{ln {I}_{m} - ln {I}_{n}} & ( 2 ) \\ \begin{matrix}{V}_{t} = {V}_{0} + {rI}_{b} ( 1 - exp ( \frac{t - {t}_{0}}{B} ) ) + \frac{R T}{2 F} ln ( \frac{{i}_{L} \cdot exp ( ( {t}_{0} - t ) / B ) - {I}_{b}}{{i}_{L} - {I}_{b}} ) \\ {t}_{f c} = t {\vert}_{{V}_{t} = {V}_{e}}\end{matrix} \} & ( 4 )\end{matrix}$$

where I₀ represents the first current corresponding to a set voltage Vₛ of the initial polarization curve, I represents the second current corresponding to the set voltage Vₛ of the current polarization curve, B represents a logarithmic decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, Iₘ represents a third current corresponding to a set voltage Vₛ of the third polarization curve, Iₙ represents a fourth current corresponding to the set voltage Vₛ of the fourth polarization curve, tₘ represents a time of the third polarization curve, that is a period from a time when activation of the fuel cell is complete to a time when the third polarization curve is obtained, tₙ represents a time of the fourth polarization curve, that is a period from the time when the activation of the fuel cell is complete to a time when the fourth polarization curve is obtained, V₀ represents the ideal electromotive force of the initial polarization curve of the fuel cell, I_{b} represents a current corresponding to a voltage Vₛ after the fuel cell is running for a time t, r represents an internal resistance of the fuel cell, R represents the gas constant, 8.31444 J/(K·mol), T represents a temperature, F represents the Faraday constant, 96485 C/mol, i_{L} represents a limiting current of the initial polarization curve, Vₜ represents a voltage of the fuel cell, Vₑ represents a voltage at the life end point of the fuel cell, and t_{fc} represents the service life of the fuel cell.

After the service life of the fuel cell is obtained, the remaining life of the fuel cell is obtained by subtracting the time t of the current polarization curve from the service life t_{fc}.

### Example 5

Processes of activating a fuel cell, obtaining initial polarization curve and current polarization curve of the fuel cell and determining service life and remaining life in this example are the same as Example 3, expect for that the reciprocal decay constant k is obtained from a third point of a third polarization curve and a fourth point of a fourth polarization curve of the fuel cell at two different times. In this case, the service life of the fuel cell is determined according to the first current, the second current, a relationship between two polarization curves in current, and a service life algorithm of the fuel cell with the following formulas:

$$\begin{matrix}\frac{I}{{I}_{0}} = \frac{1}{1 + k ( t - {t}_{0} )} & ( 5 ) \\ k = \frac{{I}_{0}}{{t}_{m} - {t}_{n}} \cdot ( \frac{1}{{I}_{m}} - \frac{1}{{I}_{n}} ) & ( 6 ) \\ {t}_{f c} = \frac{{I}_{0}}{k} ( \frac{1}{{I}_{b}} - \frac{1}{{I}_{0}} ) + {t}_{0} & ( 7 )\end{matrix}$$

where t_{fc} represents the service life of the fuel cell, I₀ represents the first current corresponding to a set voltage Vₛ of the initial polarization curve, I represents the second current corresponding to the set voltage Vₛ of the current polarization curve, k represents a reciprocal decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, Iₘ represents a third current corresponding to a set voltage Vₛ of the third polarization curve, in represents a fourth current corresponding to the set voltage Vₛ of the fourth polarization curve, tₘ represents a time of the third polarization curve, that is a period from a time when activation of the fuel cell is complete to a time when the third polarization curve is obtained, represents a time of the fourth polarization curve, that is a period from the time when the activation of the fuel cell is complete to a time when the fourth polarization curve is obtained, and I_{b} represents a current at the life end point of the fuel cell.

After the service life of the fuel cell is obtained, the remaining life of the fuel cell is obtained by subtracting the time t of the current polarization curve from the service life t_{fc}.

### Example 6

The methods of Example 1 and Example 3 are combined. In this case, the service life of the fuel cell is determined according to the first current, the second current, a relationship between two polarization curves in current, and a service life algorithm of the fuel cell with the following formulas:

$$\begin{matrix}\frac{I}{{l}_{0}} = exp ( - \frac{t - {t}_{0}}{B} ) & ( 1 ) \\ {t}_{fc} = - B \cdot ln ( \frac{{I}_{b}}{{I}_{0}} ) + {t}_{0} & ( 3 ) \\ \frac{I}{{I}_{0}} = \frac{1}{1 + k ( t - {t}_{0} )} & ( 5 ) \\ {t}_{f c} = \frac{{I}_{0}}{k} ( \frac{1}{{I}_{b}} - \frac{1}{{I}_{0}} ) + {t}_{0} & ( 7 )\end{matrix}$$

where t_{fc} represents the service life of the fuel cell, I₀ represents the first current corresponding to a set voltage Vₛ of the initial polarization curve, I represents the second current corresponding to the set voltage Vₛ of the current polarization curve, B represents a logarithmic decay constant, k represents a reciprocal decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, and I_{b} represents a current at the life end point of the fuel cell.

In this method, two values of the service life of the fuel cell can be obtained. By comparison of the two values, a more accurate and suitable service life can be obtained.

After the service life of the fuel cell is obtained, the remaining life of the fuel cell is obtained by subtracting the time t of the current polarization curve from the service life t_{fc}.

### Example 7

The methods of Example 1, Example 2 and Example 3 are combined. In this case, the service life of the fuel cell is determined according to the first current, the second current, a relationship between two polarization curves in current, and a service life algorithm of the fuel cell with the following formulas:

$$\begin{matrix}\frac{I}{{I}_{0}} = exp ( - \frac{t - {t}_{0}}{B} ) & ( 1 ) \\ {t}_{fc} = - B \cdot ln ( \frac{{I}_{b}}{{I}_{0}} ) + {t}_{0} & ( 3 ) \\ \begin{matrix}{V}_{t} = {V}_{0} + {rI}_{b} ( 1 - exp ( \frac{t - {t}_{0}}{B} ) ) + \frac{R T}{2 F} ln ( \frac{{i}_{L} \cdot exp ( ( {t}_{0} - t ) / B ) - {I}_{b}}{{i}_{L} - {I}_{b}} ) \\ {t}_{f c} = t {\vert}_{{V}_{t} = {V}_{e}}\end{matrix} \} & ( 4 ) \\ \frac{I}{{I}_{0}} = \frac{1}{1 + k ( t - {t}_{0} )} & ( 5 ) \\ {t}_{f c} = \frac{{I}_{0}}{k} ( \frac{1}{{I}_{b}} - \frac{1}{{I}_{0}} ) + {t}_{0} & ( 7 )\end{matrix}$$

where I₀ represents the first current corresponding to a set voltage Vₛ of the initial polarization curve, I represents the second current corresponding to the set voltage Vₛ of the current polarization curve, B represents a logarithmic decay constant, k represents a reciprocal decay constant, t₀ represents a time of the initial polarization curve, that is a period from a time when activation of the fuel cell is complete to a time when the initial polarization curve is obtained, t represents the time of the current polarization curve, that is a period from the time when the activation of the fuel cell is complete to a time when the current polarization curve is obtained, V₀ represents the ideal electromotive force of the initial polarization curve of the fuel cell, I_{b} represents a current corresponding to a voltage Vₛ after the fuel cell is running for a time t, r represents an internal resistance of the fuel cell, R represents the gas constant, 8.31444 J/(K·mol), T represents a temperature, F represents the Faraday constant, 96485 C/mol, i_{L} represents a limiting current of the initial polarization curve, Vₜ represents a voltage of the fuel cell, Vₑ represents a voltage at the life end point of the fuel cell, and t_{fc} represents the service life of the fuel cell.

In this method, three values of the service life of the fuel cell can be obtained. By comparison of the three values, a more accurate and suitable service life can be obtained.

After the service life of the fuel cell is obtained, the remaining life of the fuel cell is obtained by subtracting the time t of the current polarization curve from the service life t_{fc}.

It should be noted that various embodiments or examples described in the specification, as well as features of such the embodiments or examples, may be combined without conflict. Besides above examples, any other suitable combination should be regarded in the scope of the present disclosure.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example” “in a specific example” or “in some examples” in various places throughout this specification are not necessarily referring to the same embodiment or example of the present disclosure. Furthermore, the particular features, structures, materials, or characteristics may be combined in any suitable manner in one or more embodiments or examples.

It should be noted that, in this context, relational terms such as first and second are used only to distinguish an entity from another entity or to distinguish an operation from another operation without necessarily requiring or implying that the entities or operations actually have a certain relationship or sequence. Moreover, “comprise”, “include” or other variants are non-exclusive, thus a process, a method, an object or a device including a series of elements not only include such elements, but also include other elements which may not mentioned, or inherent elements of the process, method, object or device. If there is no further limitation, a feature defined by an expression of “include a . . . ” does not mean the process, the method, the object or the device can only have one elements, same elements may also be included.

It should be noted that, although the present disclosure has been described with reference to the embodiments, it will be appreciated by those skilled in the art that the disclosure includes other examples that occur to those skilled in the art to execute the disclosure. Therefore, the present disclosure is not limited to the embodiments.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A method for predicting service life and remaining life of a fuel cell, comprising:
activating the fuel cell, obtaining an initial polarization curve of the fuel cell, and selecting a first point having a first current in the initial polarization curve;
determining a life end point of the fuel cell according to the initial polarization curve and a decay ratio;
obtaining a current polarization curve of the fuel cell, and determining a second point having a second current in the current polarization curve, wherein the second point has the same voltage as the first point; and
determining the service life of the fuel cell according to the first current, the second current, a relationship between two polarization curves in current and a service life algorithm of the fuel cell, and obtaining the remaining life of the fuel cell according to the service life and a time of the current polarization curve.

2. The method according to claim 1, wherein the fuel cell comprises a proton exchange membrane fuel cell, a direct methanol fuel cell, and a solid oxide fuel cell.

3. The method according to claim 1, wherein the currents of the initial and current polarization curves meet a formula (1):
$$\frac{I}{{I}_{0}} = exp ( - \frac{t - {t}_{0}}{B} ) \qquad ( 1 )$$
where I₀ represents the first current corresponding to a set voltage Vₛ of the initial polarization curve, I represents the second current corresponding to the set voltage Vₛ of the current polarization curve, B represents a logarithmic decay constant, t₀ represents a time of the initial polarization curve, that is a period from a time when activation of the fuel cell is complete to a time when the initial polarization curve is obtained, and t represents the time of the current polarization curve, that is a period from the time when the activation of the fuel cell is complete to a time when the current polarization curve is obtained.

4. The method according to claim 3, wherein the logarithmic decay constant B is obtained by:
obtaining a third polarization curve and a fourth polarization curve of the fuel cell at two different times;
obtaining a third point of the third polarization curve according to the set voltage Vₛ wherein the third point has a third current Iₘ;
obtaining a fourth point of the fourth polarization curve according to the set voltage Vₛ, wherein the fourth point has a fourth current Iₙ; and
determining a logarithmic decay coefficient B of the fuel cell according to the third current Iₘ and the fourth current Iₙ with a formula (2):
$$B = \frac{{t}_{n} - {t}_{m}}{ln {I}_{m} - ln {I}_{n}} \qquad ( 2 )$$
where tₘ represents a period from the time when the activation of the fuel cell is complete to a time when the third polarization curve is obtained, and tₙ represents a period from the time when the activation of the fuel cell is complete to a time when the fourth polarization curve is obtained.

5. The method according to claim 3, wherein the service life algorithm of the fuel cell comprises a formula (3):
$${t}_{fc} = - B \cdot ln ( \frac{{I}_{b}}{{I}_{0}} ) + {t}_{0} \qquad ( 3 )$$
where t_{fc} represents the service life of the fuel cell, and I_{b} represents a current at the life end point of the fuel cell.

6. The method according to claim 1, wherein the decay ratio is a current ratio of a current difference between the first current and the current I_{b} at the life end point to the first current.

7. The method according to claim 6, wherein the decay ratio is in a range of 5% to 70%.

8. The method according to claim 3, wherein the service life algorithm of the fuel cell comprises a formula (4):
$$\begin{matrix}{V}_{t} = {V}_{0} + {rI}_{b} ( 1 - exp ( \frac{t - {t}_{0}}{B} ) ) + \frac{R T}{2 F} ln ( \frac{{i}_{L} \cdot exp ( ( {t}_{0} - t ) / B ) - {I}_{b}}{{i}_{L} - {I}_{b}} ) \\ {t}_{f c} = t {\vert}_{{V}_{t} = {V}_{e}}\end{matrix} \} \qquad ( 4 )$$
where V₀ represents an ideal electromotive force of the initial polarization curve of the fuel cell, I_{b} represents a current corresponding to a voltage Vₛ after the fuel cell is running for a time t, r represents an internal resistance of the fuel cell, R represents the gas constant, 8.31444 J/(K·mol), T represents a temperature, F represents the Faraday constant, 96485 C/mol, i_{L} represents a limiting current of the initial polarization curve, Vₜ represents a voltage of the fuel cell, Vₑ represents a voltage at the life end point of the fuel cell, and t_{fc} represents the service life of the fuel cell.

9. The method according to claim 1, wherein the decay ratio is a voltage ratio of a voltage difference between the ideal electromotive force and the voltage at the life end point to the ideal electromotive force.

10. The method according to claim 9, wherein the decay ratio is in a range of 5% to 70%.

11. The method according to claim 1, wherein the currents of the initial and current polarization curves meet a formula (5):
$$\frac{I}{{I}_{0}} = \frac{1}{1 + k ( t - {t}_{0} )} \qquad ( 5 )$$
where I₀ represents the first current corresponding to a set voltage Vₛ of the initial polarization curve, I represents the second current corresponding to the set voltage Vₛ of the current polarization curve, k represents a reciprocal decay constant, t₀ represents a time of the initial polarization curve, that is a period from a time when activation of the fuel cell is complete to a time when the initial polarization curve is obtained, and t represents the time of the current polarization curve, that is a period from the time when the activation of the fuel cell is complete to a time when the current polarization curve is obtained.

12. The method according to claim 11, wherein the reciprocal decay constant k is obtained by:
obtaining a third polarization curve and a fourth polarization curve of the fuel cell at two different times;
obtaining a third point of the third polarization curve according to the set voltage Vₛ, wherein the third point has a third current Iₘ;
obtaining a fourth point of the fourth polarization curve according to the set voltage Vₛ, wherein the fourth point has a fourth current Iₙ; and
determining a reciprocal decay coefficient k of the fuel cell according to the first current I₀, the third current Iₘ and the fourth current Iₙ with a formula (6):
$$k = \frac{{I}_{0}}{{t}_{m} - {t}_{n}} \cdot ( \frac{1}{{I}_{m}} - \frac{1}{{I}_{n}} ) \qquad ( 6 )$$
where tₘ represents a period from the time when the activation of the fuel cell is complete to a time when the third polarization curve is obtained, and tₙ represents a period from the time when the activation of the fuel cell is complete to a time when the fourth polarization curve is obtained.

13. The method according to claim 11, wherein the service life algorithm of the fuel cell comprises a formula (7):
$${t}_{f c} = \frac{{I}_{0}}{k} ( \frac{1}{{I}_{b}} - \frac{1}{{I}_{0}} ) + {t}_{0} \qquad ( 7 )$$
where t_{fc} represents the service life of the fuel cell, and I_{b} represents a current at the life end point of the fuel cell.

14. The method according to claim 1, wherein the remaining life of the fuel cell is obtained by subtracting the time of the current polarization curve from the service life.

15. A device for predicting service life and remaining life of a fuel cell, comprising:
an electronic load, configured to connect to the fuel cell;
a measuring assembly, configured to obtain current and voltage information of the fuel cell and record time;
a processor; and
a memory having stored therein a computer program that, when executed by the processor, causes the processor to perform the method for predicting service life and remaining life of the fuel cell according to claim 1.

16. A computer-readable storage medium having stored therein instructions that, when executed by a processor, are configured to perform the method for predicting service life and remaining life of the fuel cell according to claim 1.
